(19) United States
(12) Patent Application Publication
(10) Pub. No.: US 2013/0258258 A1
(43) Pub. Date: Oct. 3, 2013

(54) LIQUID CRYSTAL DISPLAY DEVICE

(71) Applicants: Kozo Nakamura, Osaka-shi (JP); Kazunari Tomizawa, Osaka-shi (JP)

(72) Inventors: Kozo Nakamura, Osaka-shi (JP); Kazunari Tomizawa, Osaka-shi (JP)

(73) Assignee: SHARP KABUSHIKI KAISHA, Osaka-shi, Osaka (JP)

(21) Appl. No.: 13/992,293

(22) PCT Filed: Dec. 1, 2011
(86) PCT No.: PCT/JP2011/077776

§ 371 Date: Jun. 7, 2013

(30) Foreign Application Priority Data
Dec. 8, 2010 (JP) 2010-273925

(51) Int. Cl. G02F 1/1335

(52) U.S. Cl. CPC G02F 1/133514
USPC 349/106

(57) ABSTRACT

The present invention provides a liquid crystal display device in which a decrease in primary color luminance, a decrease in chroma and an increase in power consumption are suppressed. The present invention is a liquid crystal display device including a color filter substrate where color filters of at least four colors are arranged for respective pixels, wherein a color temperature of white light emitted from a display surface is less than 12000 K.

### TECHNICAL FIELD

The present invention relates to a liquid crystal display device. More specifically, the present invention relates to a liquid crystal display device including a color filter substrate where color filters of at least four colors are arranged for respective pixels.

### BACKGROUND ART

Liquid crystal display devices have inherent advantages such that thinning and lowering of power consumption are easy and application to screens of wide sizes from small to large is enabled. Further, in recent years, display performance and functionality are greatly improved with a sudden increase in demand, and thus an extra value is being further heightened. Such liquid crystal display devices are increasingly used for wide applications such as televisions, displays for personal computers, and displays for mobile terminals in various forms of the display field.

Liquid crystal display devices (hereinafter, referred also as liquid crystal display devices of RGB system), that include a color filter substrate of three primary colors including red, green and blue as a basic technique of color display, are general as conventional liquid crystal display devices.

On the contrary, in recent years, multi-primary color liquid crystal display devices including a so-called multi-primary color filter substrate of four or more colors (for example, Patent Literatures 1 to 3), such as liquid crystal display devices including a color filter substrate further including yellow, (hereinafter, referred also as liquid crystal display devices of RGBY system) have been developed. An attention is paid to various excellent display performances that attain a color reproduction range that has not been displayed.

### CITATION LIST

### Patent Literature

Patent Literature 1: WO 2007/033957
Patent Literature 2: WO 2008/038568
Patent Literature 3: JP 2010-009064 A

### SUMMARY OF INVENTION

### Technical Problem

In the liquid crystal display devices of RGB system, such as televisions composed of the liquid crystal display devices of the RGB system, a color temperature of white light to be displayed is normally set to 12000 to 15000 K. This is because when the color temperature of the white light is set to be lower than 12000 K, an observer psychologically feels that an image is tinged with yellow under illumination of fluorescent lights and the like. Further, this is also because such setting is made in televisions using a cathode-ray tube that have been used. It is also known that the above televisions have gray scale setting means for suppressing output of white blue light so as to reduce the color temperature of the white light that is called a cinema mode.

Also in televisions composed of the conventional multi-primary color liquid crystal display devices, the color temperature of the white light is set to 12000 to 15000 K in the same manner as in televisions composed of the liquid crystal display devices of the RGB system. In such a manner, the conventional setting of the multi-primary color liquid crystal display devices is generally used. However, the biggest difference in display properties between the multi-primary color liquid crystal display devices and the conventional liquid crystal display devices of the RGB system is that a brightness of the primary colors differs. The brightness of the primary colors is influenced by chromaticity setting of white display, and particularly, is greatly changed due to an aperture ratio among primary color sub pixels and the chromaticity setting of white display, but this point has not been examined before. The multi-primary color liquid crystal display devices have room for improvement in that when the color temperature of the white light is set to 12000 to 15000 K, power consumption increases and primary color luminance is decreased due to the following reason.

The reason that the setting of the color temperature of the white light to 12000 to 15000 K causes the increase in the power consumption and the decrease in the primary color luminance is described in detail with reference to FIG. 21 to FIG. 23 by exemplifying the liquid crystal display devices of the RGBY system. FIG. 21 is a graph illustrating a relationship between a wavelength and radiant intensity of a cold cathode tube in a conventional liquid crystal display device of RGBY system. FIG. 22 is a graph illustrating a relationship between a wavelength and radiant intensity of LED in a conventional liquid crystal display device of RGBY system. In the liquid crystal display devices shown in FIG. 21 and FIG. 22, aperture areas of red, green, blue and yellow are equal to each other. FIG. 23 is a graph illustrating a relationship between a wavelength and a transmittance in a color filter in a liquid crystal display device of RGBY system and a color filter in a liquid crystal display devices of RGB system.

In the color filter substrate in the conventional liquid crystal display devices of the RGBY system, yellow is added to the conventional color filter substrates of the RGB system. At this time, white transmitted light of the color filter substrate in the liquid crystal display devices of the RGBY system shifts to a yellow side. In order to correct this, in the conventional liquid crystal display devices of the RGBY system, as shown in FIG. 17 and FIG. 18, a color temperature of the white transmitted light was raised to about 12000 K by using a backlight where a spectrum of a blue component was increased in the same manner as in the liquid crystal display devices of the RGB system. However, in the liquid crystal display devices of the RGBY system, when the blue component is increased, the primary color luminance, particularly primary color luminance of red, is decreased. Further, when chromaticity shifts to a white side, chroma of red display is also decreased. Further, as shown in FIG. 19, in the color filter of the liquid crystal display devices of the RGBY system, although transmittance of a red component is high, transmittance of a blue component is lower than that of the color filter in the liquid crystal display devices of the RGB system. However, the blue component of a backlight is increased and the red component is decreased because a backlight beam cannot be effectively utilized and luminous efficiency of a light source is decreased due to the increase in the blue component, thereby preventing lowering of power consumption.

In the conventional liquid crystal display devices of the RGBY system, when the color temperature of the white light is set to 12000 to 15000 K, display quality is deteriorated by the increase in the power consumption and the decrease in red luminance.

The present invention has been made in consideration of such circumstances, and an object thereof is to provide a liquid crystal display device for, when color filters including at least four primary colors are used, suppressing the decrease in the primary color luminance, the decrease in chroma, and the increase in power consumption.

### Solution to Problem

The present inventors made various investigations concerning liquid crystal display devices using color filters of at least four primary colors, consequently have noted that a color temperature of liquid crystal display devices of the RGBY system is set so as to be equal to a color temperature of liquid crystal display devices of the RGB system, and they found that the above various problems arise due to such setting. Particularly, the present inventors focused on a color temperature of white light at the time of maximum output, and found that the decrease in the primary color luminance, the decrease in the chroma, and the increase in the power consumption are caused because the color temperature of the white light at the time of the maximum output on all pixels is equivalent to that of the conventional liquid crystal display devices of the RGB system. It is found that when the color temperature of the white light is lowered, particularly, the color temperature of the white light at the time of the maximum output on all pixels is set to be lower than a specific value, a lot of optical properties are improved. Further, it is found that the above problem can be masterly solved, thereby completing the present invention.

That is, the present invention is a liquid crystal display device including a color filter substrate where color filters of at least four colors are arranged for respective pixels, wherein a color temperature of white light emitted from a display surface is less than 12000 K. This liquid crystal display device is hereinafter also referred as a first liquid crystal display device of the present invention.

In the specification, “the color temperature” means an absolute temperature (K) of a color of light emitted from an ideal object that completely absorbs energy called a black body (perfect radiator). Expression of a change of this color of light on an xy chromaticity diagram is a black body locus. When xy coordinates indicating white light are on the black body locus, the white light can be indicated by the color temperature. Further, when the xy coordinates indicating the white light are not on the black body locus and a deviation (Δuv) from the black body locus is between −0.02 to +0.02, a temperature of the most approximate black body is “correlated color temperature”, but in the present invention, for example, also when “the correlated color temperature of the white light is 10000 K”, “the color temperature of the white light is 10000 K”. In addition, in the present invention, that “the color temperature is 10000 K”, means that the color temperature at the time of the maximum output on all pixels is 10000 K. That is, a case in which color temperature is made to be 10000 K by setting gray scale is not included.

In the present invention, the color temperature is measured by a spectroradiometer arranged in a vertical direction of the display surface of the liquid crystal display device.

The configuration of the first liquid crystal display device of the present invention is not especially limited by other components as long as it essentially includes such components.

Preferred form of the first liquid crystal display device of the present invention is described in detail below.

It is preferable that the color temperature of the white light emitted from the display surface is 10000 K or less in the liquid crystal display device. As a result, the increase in the power consumption and the decrease in the primary color luminance can be further suppressed. Further, it is more preferable that the color temperature is 4500 K or more to 10000 K or less.

It is preferable that the color filter substrate includes color filters of at least red, green, blue and yellow, and the liquid crystal display device includes red, green, blue and yellow apertures. As a result, color reproducibility in a yellow region and a cyan region can be heightened. The apertures are light exits from which backlight beams transmitted through the color filters are emitted to the outside, and for example, the red aperture is the light exit from which the backlight beam transmitted through the red color filter is emitted to the outside.

In addition, in the present invention, red, green, blue and yellow are defined as follows. That is, “red” is a color whose dominant wavelength is 595 nm or more to 650 nm or less, and preferably, dominant wavelength is 600 nm or more to 640 nm or less. It is preferable that chromatic purity of red is 75% or more to 97% or less. Similarly, “green” is a color whose dominant wavelength is 490 nm or more to 555 nm or less, and preferably, dominant wavelength is 510 nm or more to 550 nm or less. It is preferable that chromatic purity of green is 50% or more to 80% or less. “Blue” is a color whose dominant wavelength is 450 nm or more to 490 nm or less, and preferably, dominant wavelength is 450 nm or more to 475 nm or less. It is preferable that chromatic purity of blue is 50% or more to 95% or less. On the other hand, the yellow color filter substrate of the present invention allows light in the red region and light in the green region to be partially transmitted, “yellow” is a color whose dominant wavelength is 560 to 580 nm, and chromatic purity of yellow is preferably 85% or more to 97% or less.

In the liquid crystal display device, it is preferable that when a total area ratio of the red and blue apertures is represented by RB, and a total area ratio of the green and yellow apertures is represented by GY, RB>GY. In the present invention, the areas of the color filters are areas of the regions through which the backlight beams transmit. As described above, in the multi-primary color display device, brightness of the respective primary colors is decreased. Particularly, a decrease in luminance of red light (red luminance) greatly deteriorates the display quality. Further, a decrease in luminance of blue light (blue luminance) also deteriorates the display quality. On the other hand, a decrease in luminance of green light (green luminance) hardly influences the display quality. Further, at the time of yellow display, the red light and the green light as well as the yellow light are emitted to a certain extent so that the yellow display is enabled. For this reason, a decrease in luminance of yellow light (yellow luminance) also hardly influences the display quality. Therefore, the aperture areas of the red and blue where a problem of image display may be caused by the decrease in the luminance are increased so that the luminance of a color with relatively lower luminance can be heightened. Thus, when the aperture area of color with lower luminance is enlarged, a good-quality image (video) can be displayed. The total area ratio may be derived from the total area on one pixel or from the total area on all pixels. Normally, since the color filters have the same configuration on all pixels, the total area ratio has the same value in any cases.

It is preferable that RB:GY=1.6:1.0 in the liquid crystal display device. As a result, since the aperture area of red can be further enlarged, the red luminance can be further heightened.

It is preferable that RB:GY=2.0:1.0 in the liquid crystal display device. As a result, since the aperture area of red can be further enlarged, the red luminance can be further heightened.

It is preferable that when luminance of tricolor white light whose a color temperature is 12000 K and which is emitted from a display surface of a tricolor liquid crystal display device comprising a color filter substrate where color filters of three colors including red, green and blue are arranged is 100%, luminance of the white light (white luminance) is 100% or more. That is, it is preferable that the white luminance of the first liquid crystal display device of the present invention is tricolor white luminance or more of a conventional and general liquid crystal display device of the RGB system where the color temperature of the white light is 12000 K. As a result, in comparison with the conventional and general liquid crystal display device of the RGB system, the power consumption can be suppressed.

In the present invention, the luminance is measured by a spectroradiometer arranged in a vertical direction of the display surface of the liquid crystal display device.

It is preferable that when the luminance of the white light is 100%, luminance of red light (red luminance) emitted from the display surface of the liquid crystal display device is 12% or more. As a result, a good-quality image (video) with excellent coloring of red and a red-mixed color can be displayed. When the red luminance is less than 12%, red and the red-mixed color become dark, and thus reproducibility is deteriorated. Further, it is more preferable that the red luminance is 13% or more, and 15% or more, particularly preferable.

It is preferable that when the luminance of the white light is 100%, luminance of green light (green luminance) emitted from the display surface of the liquid crystal display device is 30% or more. As a result, a good-quality image (video) with excellent coloring of green and a green-mixed color can be displayed. When the green luminance is less than 30%, green and the green-mixed color become dark, and thus reproducibility is deteriorated.

It is preferable that when the luminance of the white light is 100%, luminance of blue light (blue luminance) emitted from the display surface of the liquid crystal display device is 8% or more, and it is more preferable that the blue luminance is 10% or more. As a result, a good-quality image (video) with excellent coloring of blue and a blue-mixed color can be displayed. When the blue luminance is less than 8%, reproducibility of blue and the blue-mixed color is deteriorated. Even when the blue luminance is lower than the red and green luminance, the color reproducibility is not influenced. This is because a blue system color hardly appears dark visually even in a low luminance state and appears rich.

Further, the present invention is a liquid crystal display device including a color filter substrate where color filters of at least red, green, blue, and another color with higher brightness than the three colors including red, green and blue are arranged for respective pixels, wherein chromaticity (x, y) of white light emitted from a display surface of the liquid crystal display device is within a range that fulfills the following (1) to (4). (1) When luminance of tricolor white light at a time when a color temperature is 12000 K is 100% in a tricolor liquid crystal display device including a color filter substrate where color filters of three colors including red, green and blue are arranged, luminance of the white light is 100% or more. (2) When the luminance of the white light is 100%, luminance of red light (red luminance) emitted from the display surface of the liquid crystal display device is 12% or more. (3) When the luminance of the white light is 100%, luminance of green light (green luminance) emitted from the display surface of the liquid crystal display device is 30% or more. (4) When the luminance of the white light is 100%, luminance of blue light (blue luminance) emitted from the display surface of the liquid crystal display device is 8% or more. This liquid crystal display device is hereinafter also referred as a second liquid crystal display device of the present invention. According to the second liquid crystal display device of the present invention, the increase in the power consumption and the decrease in the red luminance are suppressed, and a good-quality image (video) can be displayed.

The configuration of the second liquid crystal display device of the present invention is not especially limited by other components as long as it essentially includes such components.

Preferred form of the second liquid crystal display device of the present invention is described in detail below.

It is preferable that the another color is yellow. As a result, color reproducibility in a yellow region and a cyan region can be heightened.

### Advantageous Effects of Invention

According to the liquid crystal display device of the present invention, the liquid crystal display device in which the decrease in the primary color luminance, the decrease in chroma, and the increase in the power consumption are suppressed can be provided.

### BRIEF DESCRIPTION OF DRAWINGS

FIG. 1 is a plan view illustrating a schematic configuration of a TFT substrate in a liquid crystal display device according to Embodiment 1.

FIG. 2 is a plan view illustrating a schematic configuration of a color filter substrate (counter substrate) in a liquid crystal display device according to Embodiment 1.

FIG. 3 is a schematic cross-sectional view illustrating a liquid crystal display device according to Embodiment 1.

FIG. 4 is a schematic cross-sectional view illustrating a liquid crystal display device according to Embodiment 2.

FIG. 5 is a schematic cross-sectional view illustrating a liquid crystal display device according to Embodiment 3.

FIG. 6 is a schematic cross-sectional view illustrating a liquid crystal display device according to Embodiment 4.

FIG. 7 is a schematic cross-sectional view illustrating a liquid crystal display device according to Embodiment 5.

FIG. 8 is a schematic cross-sectional view illustrating a liquid crystal display device according to Embodiment 6.

FIG. 9 is a schematic cross-sectional view illustrating a liquid crystal display device according to Embodiment 7.

FIG. 10 is a graph illustrating a relationship between a color temperature of white light and white luminance in liquid crystal display devices according to Embodiments 1 to 6.

FIG. 11 is a graph illustrating a relationship between a color temperature of white light and red luminance in liquid crystal display devices according to Embodiments 1 to 6.

FIG. 12 is a graph illustrating a relationship between a color temperature of white light and green luminance in liquid crystal display devices according to Embodiments 1 to 6.

FIG. 13 is a graph illustrating a relationship between a color temperature of white light and blue luminance in liquid crystal display devices according to Embodiments 1 to 6.

FIG. 14 is a graph illustrating red luminance (%) at a time when an aperture ratio is plotted on an ordinate and a color temperature of white light is plotted on an abscissa in liquid crystal display devices according to Embodiments 1 to 6.

FIG. 15 is a graph illustrating white luminance (%) at a time when an aperture ratio is plotted on an ordinate and a color temperature of white light is plotted on an abscissa in liquid crystal display devices according to Embodiments 1 to 6.

FIG. 16 is a graph illustrating red luminance (%) at a time when white luminance of white light represented by chromaticity (x, y) is 100% in Embodiment 8.

FIG. 17 is a graph illustrating white luminance (%) of white light represented by chromaticity (x, y) at a time when white luminance of Comparative Form 1 is 100% in Embodiment 8.

FIG. 18 is a graph illustrating blue luminance (%) at a time when white luminance of white light represented by chromaticity (x, y) is 100% in Embodiment 8.

FIG. 19 is a graph illustrating green luminance (%) at a time when white luminance of white light represented by chromaticity (x, y) is 100% in Embodiment 8.

FIG. 20 is a graph where FIGS. 16 to 19 are overlapped with each other.

FIG. 21 is a graph illustrating a relationship between a wavelength and radiant intensity of a cold cathode tube in a conventional liquid crystal display device of RGBY system.

FIG. 22 is a graph illustrating a relationship between a wavelength and radiant intensity of LED in a conventional liquid crystal display device of RGBY system.

FIG. 23 is a graph illustrating a relationship between a wavelength and a transmittance in a color filter in a liquid crystal display device of RGBY system and a color filter in a liquid crystal display device of RGB system.

### DESCRIPTION OF EMBODIMENTS

The present invention will be mentioned in more detail in the following embodiments, but is not limited to these embodiments.

### Embodiment 1

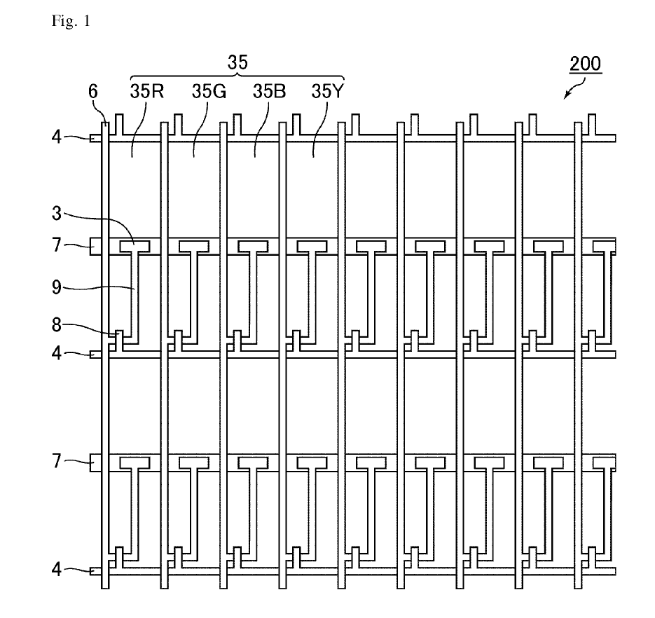

A configuration of a liquid crystal display device according to Embodiment 1 of the present invention is described. In addition, the configuration of the liquid crystal display device of the present invention is not limited to this. FIG. 1 is a plan view illustrating a schematic configuration of a TFT substrate in a liquid crystal display device according to Embodiment 1. In a TFT substrate 200, as shown in FIG. 1, matrix wirings composed of scanning lines 4 and signal lines 6 are arranged on a glass substrate, and thin film transistors (TFTs) 8 are arranged at each of intersection points of the matrix wirings. Transparent electrodes 35 (35R, 35G, 35B and 35Y) made from a transparent conductive material such as indium tin oxide (ITO) are arranged on regions surrounded by the matrix wirings, respectively. Gate electrodes of the TFTs 8 are connected to the scanning lines 4, source electrodes are connected to the signal lines 6, and drain electrodes are connected to transparent electrodes 35 via drain lead-out wirings 9. Further, the transparent electrodes 35R, 35G, 35B and 35Y are respectively arranged so as to be opposed to color filters 10R, 10G, 10B and 10Y of red, green, blue and yellow arranged on a counter substrate 100, described later, in the liquid crystal display device. In the present embodiment, as shown in FIG. 1, the scanning lines 4 and the signal lines 6 are arranged so that sizes of the transparent electrodes 35R, 35G, 35B and 35Y are equal to each other. Further, auxiliary capacity wirings 7 for maintaining a voltage applied to the transparent electrodes 35 is arranged so as to be parallel with the scanning lines 4. The auxiliary capacity wirings 7 are respectively opposed to ends of the drain lead-out wirings 9 via an insulating film so as to compose an auxiliary capacitor 3.

FIG. 2 is a plan view illustrating a schematic configuration of a color filter substrate (counter substrate) in a liquid crystal display device according to Embodiment 1. In a counter substrate 100, as shown in FIG. 2, the color filters 10R, 10G, 10B and 10Y of red, green, blue and yellow are stripe-arranged in the stated order, and a black matrix 10BM is arranged between the filters. In addition, the color filters 10R, 10G, 10B and 10Y respectively select colors of light transmitting therethrough. The color filters 10R, 10G and 10B of red, green and blue respectively allow a red component, a green component and a blue component of incident light to mainly transmit, and the color filter 10Y of yellow allows both the red component and the green component of incident light to mainly transmit. The color filters 10R, 10G, 10B and 10Y are respectively arranged in the liquid crystal display device so as to be opposed to the transparent electrodes 35R, 35G, 35B and 35Y arranged on the TFT substrate 200, described above. The black matrix 10BM is arranged in the liquid crystal display device so as to be opposed to the scanning lines 4 and the signal lines 6. In Embodiment 1, as shown in FIG. 2, the color filters 10R, 10G, 10B and 10Y are formed so that their areas are the same as each other. That is, in the liquid crystal display device of Embodiment 1, aperture areas of red, green, blue and yellow are the same as each other.

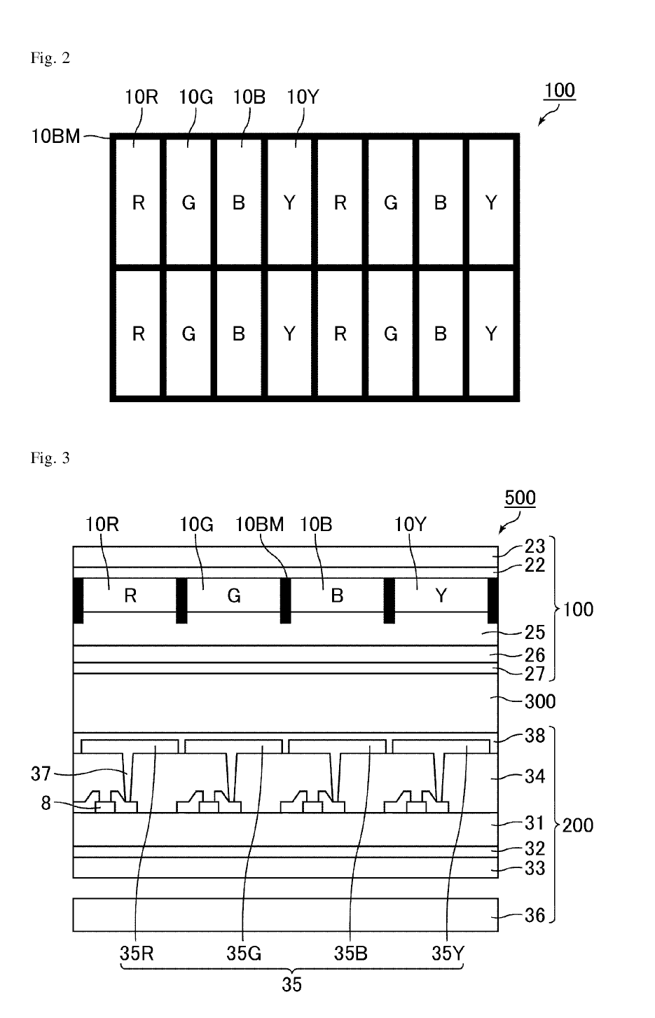

FIG. 3 is a schematic cross-sectional view illustrating a liquid crystal display device according to Embodiment 1.

A liquid crystal display device 500 according to Embodiment 1 of the present invention, as shown in FIG. 3, has a configuration that a liquid crystal layer 300 is interposed between the counter substrate 100 and the TFT substrate 200.

The counter substrate 100 includes a retarder 22 and a polarizing plate 23 on an outside (observation surface side) of a glass substrate 21, and includes the color filters 10R, 10G, 10B and 10Y of red, green, blue and yellow, the black matrix 10BM, an overcoat layer 25, a counter electrode 26 and an alignment film 27 on an inside (rear face side) of the glass substrate 21.

The retarder 22 adjusts a polarizing state of light transmitting therethrough. The polarizing plate 23 allows only lights of specific polarizing components to transmit. In the present embodiment, the arrangements and the configurations of the retarder 22 and the polarizing plate 23 are adjusted, so as to give a function of viewing angle compensation.

The overcoat layer 25 prevents contaminant from being extracted and leached from the filters 10R, 10G, 10B and 10Y of red, green, blue and yellow into the liquid crystal layer 300, and planarizes the surface of the counter substrate 100. The counter electrode 26 is opposed to the transparent electrodes 35R, 35G, 35B and 35Y arranged on the TFT substrate 200 side via the liquid crystal layer 300, and is used for applying a voltage to the liquid crystal layer 300 so as to drive liquid crystal molecules. The counter electrode 26 is made from a transparent conductive material such as indium tin oxide (ITO). The alignment film 27 controls the alignment of the liquid crystal molecules in the liquid crystal layer 300.

On the other hand, the TFT substrate 200 includes a retarder 32 and a polarizing plate 33 on an outside (rear face side) of a glass substrate 31, and includes the thin film transistors (TFTs) 8, an interlayer insulating film 34, the transparent electrodes 35 (35R, 35G, 35B and 35Y), an alignment film 38, and the like on an inside (observation surface side) of the glass substrate 31.

The retarder 32 adjusts a polarizing state of light transmitting therethrough in the same manner as in the retarder 22, and the polarizing plate 33 allows only lights of specific polarizing components to transmit in the same manner as in the polarizing plate 23. In the present embodiment, the polarizing plate 33 is arranged so as to be optically perpendicular to the polarizing plate arranged on the counter substrate 100.

The transparent electrodes 35 (35R, 35G, 35B and 35Y) are arranged for the respective color filters on the counter substrate 100 side, and apply a voltage to the liquid crystal layer 300 in each color filter region so as to drive the liquid crystal molecules. The alignment film 38 controls the alignment of the liquid crystal molecules in the liquid crystal layer 300 in the same manner as in the alignment film 27.

A backlight 36 that is used for display is arranged to the back surface side (rear face side) of the TFT substrate 200.

### Comparative Form 1

The liquid crystal display device 500 according to Embodiment 1 includes the color filters 10R, 10G, 10B and 10Y of four colors including red, green, blue and yellow, but a liquid crystal display device according to Comparative Form 1 includes color filters of three colors including red, green, and blue. The color filters of three colors are formed so that their areas are the same as each other, and the liquid crystal display device according to Comparative Form 1 includes red, green, and blue apertures whose areas are equal to each other. Further, in the liquid crystal display device according to Comparative Form 1, a backlight is set so that the color temperature of the white light is 12000 K. The liquid crystal display device according to Comparative Form is similar to the liquid crystal display device 500 according to Embodiment 1 except for the above different point.

In the liquid crystal display device according to Embodiment 1, the color temperature of the white light was changed into 4500 K to 20000 K, and white luminance, and red luminance, green luminance, and blue luminance (%) at a time when the white luminance was 100% were measured. In addition, the white luminance is luminance when the white luminance (the tricolor white luminance) in Comparative Form 1 (the liquid crystal display device that includes the color filter substrate where the color filters of the three colors including red, blue and green are arranged, and where the color temperature of the white light to be emitted is 12000 K) is 100%. The result is shown in Table 1. The color temperature of the white light is 4500 K in Example 1, the color temperature of the white light is 5000 K in Example 2, the color temperature of the white light is 5500 K in Example 3, the color temperature of the white light is 6000K in Example 4, the color temperature of the white light is 6500 K in Example 5, the color temperature of the white light is 7000 K in Example 6, the color temperature of the white light is 7500 K in Example 7, the color temperature of the white light is 8000 K in Example 8, the color temperature of the white light is 9000 K in Example 9, and the color temperature of the white light is 10000 K in Example 10. Further, the color temperature of the white light is 12000 K in Comparative Example 1, the color temperature of the white light is 15000 K in Comparative Example 2, and the color temperature of the white light is 20000 K in Comparative Example 3.

The color temperature and the luminance were measured by a super-low luminance spectroradiometer SR-UL1 (manufactured by Topcon Corporation) arranged in a vertical direction of the display surface of the liquid crystal display device.

TABLE 1

| | | | Color | Red | Green | Blue | White |
|---|---|---|---|---|---|---|---|
| | x | y | temperature [K] | luminance | luminance | luminance | luminance |
| Example 1 | 0.3618 | 0.3707 | 4500 | 14.4% | 33.2% | 6.0% | 133.8% |
| Example 2 | 0.3455 | 0.3585 | 5000 | 13.6% | 33.8% | 6.6% | 131.5% |
| Example 3 | 0.3323 | 0.3475 | 5500 | 13.1% | 34.2% | 7.1% | 129.0% |
| Example 4 | 0.3216 | 0.3377 | 6000 | 12.6% | 34.6% | 7.6% | 126.4% |
| Example 5 | 0.3128 | 0.3292 | 6500 | 12.2% | 34.8% | 8.0% | 124.1% |
| Example 6 | 0.3054 | 0.3217 | 7000 | 11.9% | 35.0% | 8.4% | 121.8% |
| Example 7 | 0.2991 | 0.3151 | 7500 | 11.6% | 35.2% | 8.8% | 119.8% |
| Example 8 | 0.2938 | 0.3092 | 8000 | 11.4% | 35.3% | 9.1% | 118.0% |
| Example 9 | 0.2850 | 0.2993 | 9000 | 11.0% | 35.6% | 9.6% | 114.7% |
| Example 10 | 0.2783 | 0.2913 | 10000 | 10.8% | 35.7% | 10.1% | 112.0% |
| Comparative | 0.2684 | 0.2792 | 12000 | 10.4% | 35.9% | 10.8% | 107.6% |
| Example 1 | | | | | | | |
| Comparative | 0.2587 | 0.2667 | 15000 | 10.0% | 36.1% | 11.6% | 103.0% |
| Example 2 | | | | | | | |
| Comparative | 0.2491 | 0.2538 | 20000 | 9.5% | 36.3% | 12.5% | 98.4% |
| Example 3 | | | | | | | |

As shown in Table 1, the color temperature of the white light was set to 10000 K or less, so that the white luminance and the red luminance were improved. As a result, in the liquid crystal display device of the RGBY system, the red luminance can be improved, and low power consumption can be achieved. On the other hand, when the color temperature of the white light is lowered, the blue luminance is decreased, but even when the blue luminance is decreased, image quality is not greatly influenced. In addition, even when the color temperature of the white light was set to be lower, the green luminance did not greatly change.

In view of the image quality, it is preferable that the red luminance is 12% or more, the green luminance is 30% or more, and the blue luminance is 8% or more. Therefore, in the liquid crystal display device according to Embodiment 1 where the red, green, blue and yellow aperture areas are equal to each other, it is more preferable that the color temperature of the white light is 5500 K to 6500 K (Examples 3 to 5).

### Embodiment 2

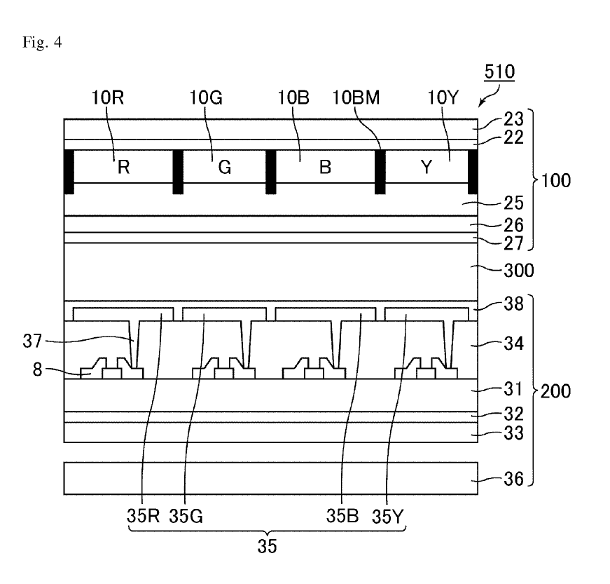

FIG. 4 is a schematic cross-sectional view illustrating a liquid crystal display device according to Embodiment 2. In the liquid crystal display device 500 according to Embodiment 1, the red, green, blue and yellow aperture areas are equal to each other. However, in a liquid crystal display device 510 according to Embodiment 2, as shown in FIG. 4, a total area of the color filters 10R and 10B is 1.2 times as large as that of the color filters 10G and 10Y, and a total area ratio of the red and blue apertures is 1.2 times as large as a total area ratio of the green and yellow apertures. Except for the above, the liquid crystal display device 510 according to Embodiment 2 is similar to the liquid crystal display device 500 according to Embodiment 1.

In the liquid crystal display device according to Embodiment 2, the color temperature of the white light was changed into 4500 K to 20000 K, and the white luminance, and the red luminance, the green luminance and the blue luminance (%) at the time when the white luminance was 100% were measured. In addition, the white luminance is luminance when the white luminance (the tricolor white luminance) in Comparative Form 1 (the liquid crystal display device that includes the color filter substrate where the color filters of the three colors including red, blue and green are arranged, and where the color temperature of the white light to be emitted is 12000 K) is 100%. The result is shown in Table 2. The color temperature of the white light is 4500 K in Example 11, the color temperature of the white light is 5000 K in Example 12, the color temperature of the white light is 5500 K in Example 13, the color temperature of the white light is 6000 K in Example 14, the color temperature of the white light is 6500 K in Example 15, the color temperature of the white light is 7000 K in Example 16, the color temperature of the white light is 7500 K in Example 17, the color temperature of the white light is 8000 K in Example 18, the color temperature of the white light is 9000 K in Example 19, and the color temperature of the white light is 10000 K in Example 20. Further, the color temperature of the white light is 12000 K in Comparative Example 4, the color temperature of the white light is 15000 K in Comparative Example 5, and the color temperature of the white light is 20000 K in Comparative Example 6.

The color temperature and the luminance were measured by a super-low luminance spectroradiometer SR-UL1 (manufactured by Topcon Corporation) arranged in a vertical direction of the display surface of the liquid crystal display device.

TABLE 2

| | | | Color | Red | Green | Blue | White |
|---|---|---|---|---|---|---|---|
| | x | y | temperature [K] | luminance | luminance | luminance | luminance |
| Example 11 | 0.3618 | 0.3707 | 4500 | 16.0% | 32.6% | 6.7% | 137.1% |
| Example 12 | 0.3455 | 0.3585 | 5000 | 15.2% | 33.1% | 7.3% | 134.3% |
| Example 13 | 0.3323 | 0.3475 | 5500 | 14.6% | 33.5% | 7.9% | 131.4% |
| Example 14 | 0.3216 | 0.3377 | 6000 | 14.0% | 33.8% | 8.4% | 128.6% |
| Example 15 | 0.3128 | 0.3292 | 6500 | 13.6% | 34.0% | 8.9% | 126.1% |
| Example 16 | 0.3054 | 0.3217 | 7000 | 13.3% | 34.2% | 9.3% | 123.6% |
| Example 17 | 0.2991 | 0.3151 | 7500 | 13.0% | 34.4% | 9.7% | 121.5% |
| Example 18 | 0.2938 | 0.3092 | 8000 | 12.8% | 34.5% | 10.0% | 119.5% |
| Example 19 | 0.2850 | 0.2993 | 9000 | 12.4% | 34.7% | 10.6% | 116.1% |
| Example 20 | 0.2783 | 0.2913 | 10000 | 12.1% | 34.8% | 11.1% | 113.2% |
| Comparative | 0.2684 | 0.2792 | 12000 | 11.6% | 35.0% | 11.9% | 108.9% |
| Example 4 | | | | | | | |
| Comparative | 0.2587 | 0.2667 | 15000 | 11.2% | 35.1% | 12.7% | 104.2% |
| Example 5 | | | | | | | |
| Comparative | 0.2491 | 0.2538 | 20000 | 10.8% | 35.2% | 13.7% | 99.4% |
| Example 6 | | | | | | | |

As shown in Table 2, the color temperature of the white light was set to 10000 K or less, so that the white luminance and the red luminance were improved. As a result, in the liquid crystal display device of the RGBY system, the red luminance can be improved, and low power consumption can be achieved. On the other hand, when the color temperature of the white light is lowered, the blue luminance is decreased, but even when the blue luminance is decreased, image quality is not greatly influenced. In addition, even when the color temperature of the white light was set to be lower, the green luminance did not greatly change.

In view of the image quality, it is preferable that the red luminance is 12% or more, the green luminance is 30% or more, and the blue luminance is 8% or more. Therefore, in the liquid crystal display device according to Embodiment 2, it is more preferable that the color temperature of the white light is 5000 K to 10000 K (Examples 12 to 20).

In liquid crystal display device according to Embodiment 2, it was found that when the total area ratio of the red and blue apertures was made to be 1.2 times as large as the total area ratio of the green and yellow apertures, the red luminance could be further improved in comparison with the liquid crystal display device according to Embodiment 1.

### Embodiment 3

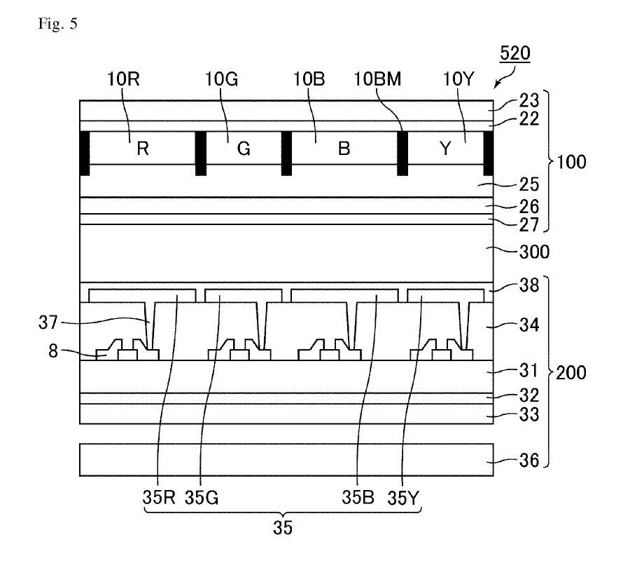

FIG. 5 is a schematic cross-sectional view illustrating a liquid crystal display device according to Embodiment 3. In the liquid crystal display device 500 according to Embodiment 1, the areas of the color filters 10R, 10G, 10B and 10Y are equal to each other. However, in a liquid crystal display device 520 according to Embodiment 3, as shown in FIG. 5, a total area of the color filters 10R and 10B is 1.4 times as large as that of the color filters 10G and 10Y, and a total area ratio of the red and blue apertures is 1.4 times as large as a total area ratio of the green and yellow apertures. Except for the above, the liquid crystal display device 520 according to Embodiment 3 is similar to the liquid crystal display device 500 according to Embodiment 1.

In the liquid crystal display device according to Embodiment 3, the color temperature of the white light was changed into 4500 K to 20000 K, and the white luminance, and the red luminance, the green luminance and the blue luminance (%) at the time when the white luminance was 100% were measured. In addition, the white luminance is luminance when the white luminance in Comparative Form 1 (the liquid crystal display device that includes the color filter substrate where the color filters of the three colors including red, blue and green are arranged, and where the color temperature of the white light to be emitted is 12000 K) is 100%. The result is shown in Table 3. The color temperature of the white light is 4500 K in Example 21, the color temperature of the white light is 5000 K in Example 22, the color temperature of the white light is 5500 K in Example 23, the color temperature of the white light is 6000 K in Example 24, the color temperature of the white light is 6500 K in Example 25, the color temperature of the white light is 7000 K in Example 26, the color temperature of the white light is 7500 K in Example 27, the color temperature of the white light is 8000 K in Example 28, the color temperature of the white light is 9000 K in Example 29, and the color temperature of the white light is 10000 K in Example 30. Further, the color temperature of the white light is 12000 K in Comparative Example 7, the color temperature of the white light is 15000 K in Comparative Example 8, and the color temperature of the white light is 20000 K in Comparative Example 9.

The color temperature and the luminance were measured by a super-low luminance spectroradiometer SR-UL1 (manufactured by Topcon Corporation) arranged in a vertical direction of the display surface of the liquid crystal display device.

TABLE 3

| | | | Color | Red | Green | Blue | White |
|---|---|---|---|---|---|---|---|
| | x | y | temperature [K] | luminance | luminance | luminance | luminance |
| Example 21 | 0.3618 | 0.3707 | 4500 | 17.3% | 32.0% | 7.2% | 137.3% |
| Example 22 | 0.3455 | 0.3585 | 5000 | 16.4% | 32.6% | 7.9% | 135.0% |
| Example 23 | 0.3323 | 0.3475 | 5500 | 15.7% | 33.0% | 8.4% | 132.4% |
| Example 24 | 0.3216 | 0.3377 | 6000 | 15.2% | 33.2% | 9.0% | 129.9% |
| Example 25 | 0.3128 | 0.3292 | 6500 | 14.7% | 33.5% | 9.4% | 127.5% |
| Example 26 | 0.3054 | 0.3217 | 7000 | 14.3% | 33.7% | 9.8% | 125.3% |
| Example 27 | 0.2991 | 0.3151 | 7500 | 14.0% | 33.8% | 10.2% | 123.3% |
| Example 28 | 0.2938 | 0.3092 | 8000 | 13.8% | 33.9% | 10.6% | 121.4% |
| Example 29 | 0.2850 | 0.2993 | 9000 | 13.4% | 34.1% | 11.1% | 118.2% |
| Example 30 | 0.2783 | 0.2913 | 10000 | 13.0% | 34.2% | 11.6% | 115.5% |
| Comparative | 0.2684 | 0.2792 | 12000 | 12.5% | 34.4% | 12.4% | 111.3% |
| Example 7 | | | | | | | |
| Comparative | 0.2587 | 0.2667 | 15000 | 12.1% | 34.4% | 13.3% | 106.7% |
| Example 8 | | | | | | | |
| Comparative | 0.2491 | 0.2538 | 20000 | 11.6% | 34.5% | 14.3% | 102.0% |
| Example 9 | | | | | | | |

As shown in Table 3, the color temperature of the white light was set to 10000 K or less, so that the white luminance and the red luminance were improved. As a result, in the liquid crystal display device of the RGBY system, the red luminance can be improved, and low power consumption can be achieved. On the other hand, when the color temperature of the white light is lowered, the blue luminance is decreased, but even when the blue luminance is decreased, image quality is not greatly influenced. In addition, even when the color temperature of the white light was set to be lower, the green luminance did not greatly change.

In view of the image quality, it is more preferable that the red luminance is 12% or more, the green luminance is 30% or more, and the blue luminance is 8% or more. However, in the liquid crystal display device according to Embodiment 3, when the color temperature of the white light was 4500 K to 10000 K (Examples 21 to 30), the above condition was fulfilled. Further, also when the color temperature of the white light was 12000 K and 15000 K (Comparative Examples 7 and 8), the above condition was fulfilled, but the red luminance and the white luminance were decreased further in comparison with the case where the color temperature of the white light was 4500 K to 10000 K.

In the liquid crystal display device according to Embodiment 3, it was found that when the total area ratio of the red and blue apertures was made to be 1.4 times as large as the total area ratio of the green and yellow apertures, the red luminance could be further improved in comparison with the liquid crystal display device according to Embodiment 2.

### Embodiment 4

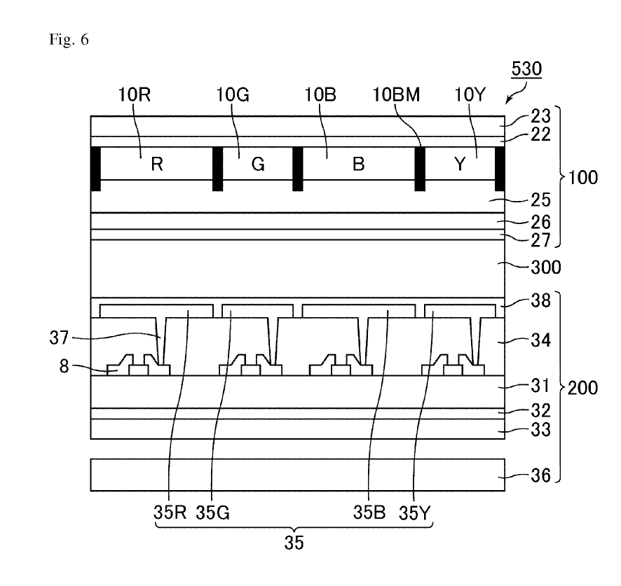

FIG. 6 is a schematic cross-sectional view illustrating a liquid crystal display device according to Embodiment 4. In the liquid crystal display device 500 according to Embodiment 1, the areas of the color filters 10R, 10G, 10B and 10Y are equal to each other. However, in a liquid crystal display device 530 according to Embodiment 2, as shown in FIG. 6, a total area of the color filters 10R and 10B is 1.6 times as large as that of the color filters 10G and 10Y, and a total area ratio of the red and blue apertures is 1.6 times as large as a total area ratio of the green and yellow apertures. Except for the above, the liquid crystal display device 530 according to Embodiment 4 is similar to the liquid crystal display device 500 according to Embodiment 1.

In the liquid crystal display device according to Embodiment 4, the color temperature of the white light was changed into 4500 K to 20000 K, and the white luminance, and the red luminance, the green luminance and the blue luminance (o) at the time when the white luminance was 100% were measured. In addition, the white luminance is luminance when the white luminance (the tricolor white luminance) in Comparative Form 1 (the liquid crystal display device that includes the color filter substrate where the color filters of the three colors including red, blue and green are arranged, and where the color temperature of the white light to be emitted is 12000 K) is 100%. The result is shown in Table 4. The color temperature of the white light is 4500 K in Example 31, the color temperature of the white light is 5000 K in Example 32, the color temperature of the white light is 5500 K in Example 33, the color temperature of the white light is 6000 K in Example 34, the color temperature of the white light is 6500 K in Example 35, the color temperature of the white light is 7000 K in Example 36, the color temperature of the white light is 7500 K in Example 37, the color temperature of the white light is 8000 K in Example 38, the color temperature of the white light is 9000 K in Example 39, and the color temperature of the white light is 10000 K in Example 40. Further, the color temperature of the white light is 12000 K in Comparative Example 10, the color temperature of the white light is 15000 K in Comparative Example 11, and the color temperature of the white light is 20000 K in Comparative Example 12.

The color temperature and the luminance were measured by a super-low luminance spectroradiometer SR-UL1 (manufactured by Topcon Corporation) arranged in a vertical direction of the display surface of the liquid crystal display device.

TABLE 4

| | | | Color | Red | Green | Blue | White |
|---|---|---|---|---|---|---|---|
| | x | y | temperature [K] | luminance | luminance | luminance | luminance |
| Example 31 | 0.3618 | 0.3707 | 4500 | 18.5% | 31.6% | 7.5% | 133.7% |
| Example 32 | 0.3455 | 0.3585 | 5000 | 17.5% | 32.1% | 8.2% | 132.3% |
| Example 33 | 0.3323 | 0.3475 | 5500 | 16.8% | 32.5% | 8.7% | 130.9% |
| Example 34 | 0.3216 | 0.3377 | 6000 | 16.2% | 32.8% | 9.2% | 129.0% |
| Example 35 | 0.3128 | 0.3292 | 6500 | 15.7% | 33.0% | 9.7% | 127.4% |
| Example 36 | 0.3054 | 0.3217 | 7000 | 15.3% | 33.2% | 10.1% | 125.6% |
| Example 37 | 0.2991 | 0.3151 | 7500 | 14.9% | 33.4% | 10.4% | 124.2% |
| Example 38 | 0.2938 | 0.3092 | 8000 | 14.7% | 33.5% | 10.8% | 122.6% |
| Example 39 | 0.2850 | 0.2993 | 9000 | 14.2% | 33.7% | 11.3% | 120.2% |
| Example 40 | 0.2783 | 0.2913 | 10000 | 13.8% | 33.8% | 11.8% | 117.8% |
| Comparative | 0.2684 | 0.2792 | 12000 | 13.3% | 33.9% | 12.6% | 114.3% |
| Example 10 | | | | | | | |
| Comparative | 0.2587 | 0.2667 | 15000 | 12.7% | 34.1% | 13.4% | 110.4% |
| Example 11 | | | | | | | |
| Comparative | 0.2491 | 0.2538 | 20000 | 12.2% | 34.2% | 14.3% | 106.4% |
| Example 12 | | | | | | | |

As shown in Table 4, the color temperature of the white light was set to 10000 K or less, so that the white luminance and the red luminance were improved. As a result, in the liquid crystal display device of the RGBY system, the red luminance can be improved, and low power consumption can be achieved. On the other hand, when the color temperature of the white light is lowered, the blue luminance is decreased, but even when the blue luminance is decreased, image quality is not greatly influenced. In addition, even when the color temperature of the white light was set to be lower, the green luminance did not greatly change.

In view of the image quality, it is more preferable that the red luminance is 12% or more, the green luminance is 30% or more, and the blue luminance is 8% or more. However, in the liquid crystal display device according to Embodiment 4, when the color temperature of the white light was 4500 K to 10000 K (Examples 31 to 40), the above condition was fulfilled. Further, also when the color temperature of the white light was 12000 K and 20000 K (Comparative Examples 10 to 12), the above condition was fulfilled, but the red luminance and the white luminance were decreased further in comparison with the case where the color temperature of the white light was 4500 K to 10000 K. Further, in view of the image quality, it is particularly preferable that the red luminance is 15% or more, the green luminance is 30% or more, and the blue luminance is 10% or more. However, in the liquid crystal display device according to Embodiment 4, when the color temperature of the white light was 7000 K (Example 36), the above condition was fulfilled.

In the liquid crystal display device according to Embodiment 4, it was found that when the total area ratio of the red and blue apertures was made to be 1.6 times as large as the total area ratio of the green and yellow apertures, the red luminance could be further improved in comparison with the liquid crystal display device according to Embodiment 3.

### Embodiment 5

FIG. 7 is a schematic cross-sectional view illustrating a liquid crystal display device according to Embodiment 5. In the liquid crystal display device 500 according to Embodiment 1, the areas of the color filters 10R, 10G, 10B and 10Y are equal to each other. However, in a liquid crystal display device 540 according to Embodiment 5, as shown in FIG. 7, a total area of the color filters 10R and 10B is 1.8 times as large as that of the color filters 10G and 10Y, and a total area ratio of the red and blue apertures is 1.8 times as large as a total area ratio of the green and yellow apertures. Except for the above, the liquid crystal display device 540 according to Embodiment 5 is similar to the liquid crystal display device 500 according to Embodiment 1.

In the liquid crystal display device according to Embodiment 5, the color temperature of the white light was changed into 4500 K to 20000 K, and the white luminance, and the red luminance, the green luminance and the blue luminance (%) at the time when the white luminance was 100% were measured. In addition, the white luminance is luminance when the white luminance (the tricolor white luminance) in Comparative Form 1 (the liquid crystal display device that includes the color filter substrate where the color filters of the three colors including red, blue and green are arranged, and where the color temperature of the white light to be emitted is 12000 K) is 100%. The result is shown in Table 5. The color temperature of the white light is 4500 K in Example 41, the color temperature of the white light is 5000 K in Example 42, the color temperature of the white light is 5500 K in Example 43, the color temperature of the white light is 6000 K in Example 44, the color temperature of the white light is 6500 K in Example 45, the color temperature of the white light is 7000 K in Example 46, the color temperature of the white light is 7500 K in Example 47, the color temperature of the white light is 8000 K in Example 48, the color temperature of the white light is 9000 K in Example 49, and the color temperature of the white light is 10000 K in Example 50. Further, the color temperature of the white light is 12000 K in Comparative Example 13, the color temperature of the white light is 15000 K in Comparative Example 14, and the color temperature of the white light is 20000 K in Comparative Example 15.

The color temperature and the luminance were measured by a super-low luminance spectroradiometer SR-UL1 (manufactured by Topcon Corporation) arranged in a vertical direction of the display surface of the liquid crystal display device.

TABLE 5

| | | | Color | Red | Green | Blue | White |
|---|---|---|---|---|---|---|---|
| | x | y | temperature [K] | luminance | luminance | luminance | luminance |
| Example 41 | 0.3618 | 0.3707 | 4500 | 19.6% | 31.0% | 8.1% | 136.3% |
| Example 42 | 0.3455 | 0.3585 | 5000 | 18.6% | 31.6% | 8.8% | 134.5% |
| Example 43 | 0.3323 | 0.3475 | 5500 | 17.8% | 31.9% | 9.4% | 132.4% |
| Example 44 | 0.3216 | 0.3377 | 6000 | 17.1% | 32.2% | 10.0% | 130.3% |
| Example 45 | 0.3128 | 0.3292 | 6500 | 16.6% | 32.4% | 10.4% | 128.3% |
| Example 46 | 0.3054 | 0.3217 | 7000 | 16.2% | 32.6% | 10.9% | 126.3% |
| Example 47 | 0.2991 | 0.3151 | 7500 | 15.9% | 32.7% | 11.2% | 124.6% |
| Example 48 | 0.2938 | 0.3092 | 8000 | 15.6% | 32.8% | 11.6% | 122.9% |
| Example 49 | 0.2850 | 0.2993 | 9000 | 15.1% | 33.0% | 12.2% | 120.0% |
| Example 50 | 0.2783 | 0.2913 | 10000 | 14.7% | 33.1% | 12.7% | 117.5% |
| Comparative | 0.2684 | 0.2792 | 12000 | 14.2% | 33.2% | 13.5% | 113.5% |
| Example 13 | | | | | | | |
| Comparative | 0.2587 | 0.2667 | 15000 | 13.7% | 33.3% | 14.4% | 109.4% |
| Example 14 | | | | | | | |
| Comparative | 0.2491 | 0.2538 | 20000 | 13.1% | 33.4% | 15.4% | 105.1% |
| Example 15 | | | | | | | |

As shown in Table 5, the color temperature of the white light was set to 10000 K or less, so that the white luminance and the red luminance were improved. As a result, in the liquid crystal display device of the RGBY system, the red luminance can be improved, and low power consumption can be achieved. On the other hand, when the color temperature of the white light is lowered, the blue luminance is decreased, but even when the blue luminance is decreased, image quality is not greatly influenced. In addition, even when the color temperature of the white light was set to be lower, the green luminance did not greatly change.

In view of the image quality, it is more preferable that the red luminance is 12% or more, the green luminance is 30% or more, and the blue luminance is 8% or more. However, in the liquid crystal display device according to Embodiment 5, when the color temperature of the white light was 4500 K to 10000 K (Examples 41 to 50), the above condition was fulfilled. Further, also when the color temperature of the white light was 12000 K to 20000 K (Comparative Examples 13 to 15), the above condition was fulfilled, but the red luminance and the white luminance were decreased further in comparison with the case where the color temperature of the white light was 4500 K to 10000 K. Further, in view of the image quality, it is particularly preferable that the red luminance is 15% or more, the green luminance is 30% or more, and the blue luminance is 10% or more. However, in the liquid crystal display device according to Embodiment 5, when the color temperature of the white light was 6000 K to 9000 K (Examples 44 to 49), the above condition was fulfilled.

In the liquid crystal display device according to Embodiment 5, it was found that when the total area ratio of the red and blue apertures was made to be 1.8 times as large as the total area ratio of the green and yellow apertures, the red luminance could be further improved in comparison with the liquid crystal display device according to Embodiment 4.

### Embodiment 6

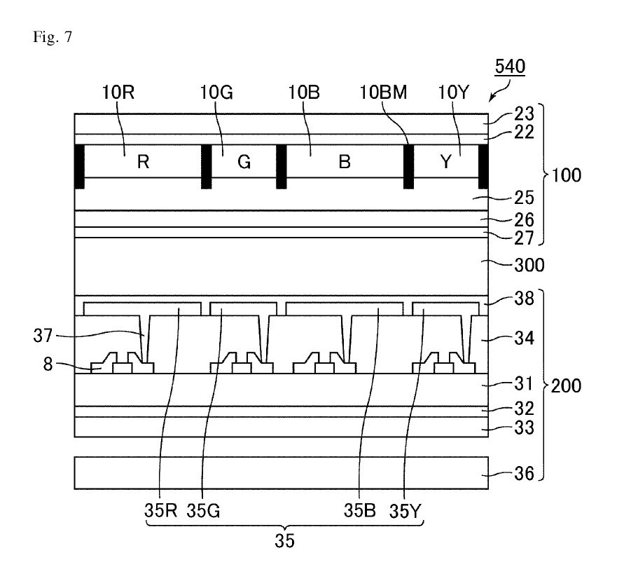

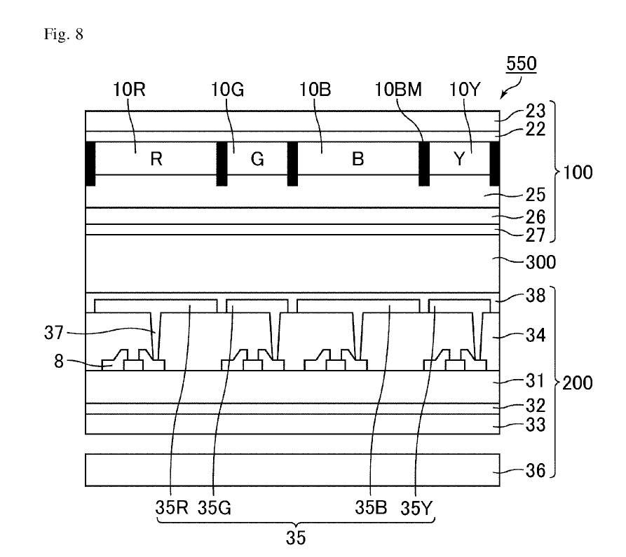

FIG. 8 is a schematic cross-sectional view illustrating a liquid crystal display device according to Embodiment 6. In the liquid crystal display device 500 according to Embodiment 1, the areas of the color filters 10R, 10G, 10B and 10Y are equal to each other. However, in a liquid crystal display device 550 according to Embodiment 6, as shown in FIG. 8, a total area of the color filters 10R and 10B is 2.0 times as large as that of the color filters 10G and 10Y, and a total area ratio of the red and blue apertures is 2.0 times as large as a total area ratio of the green and yellow apertures. Except for the above, the liquid crystal display device 550 according to Embodiment 6 is similar to the liquid crystal display device 500 according to Embodiment 1.

In the liquid crystal display device according to Embodiment 6, the color temperature of the white light was changed into 4500 K to 20000 K, and the white luminance, and the red luminance, the green luminance and the blue luminance (o) at the time when the white luminance was 100% were measured. In addition, the white luminance is luminance when the white luminance (the tricolor white luminance) in Comparative Form 1 (the liquid crystal display device that includes the color filter substrate where the color filters of the three colors including red, blue and green are arranged, and where the color temperature of the white light to be emitted is 12000 K) is 100%. The result is shown in Table 6. The color temperature of the white light is 4500 K in Example 51, the color temperature of the white light is 5000 K in Example 52, the color temperature of the white light is 5500 K in Example 53, the color temperature of the white light is 6000 K in Example 54, the color temperature of the white light is 6500 K in Example 55, the color temperature of the white light is 7000 K in Example 56, the color temperature of the white light is 7500 K in Example 57, the color temperature of the white light is 8000 K in Example 58, the color temperature of the white light is 9000 K in Example 59, and the color temperature of the white light is 10000 K in Example 60. Further, the color temperature of the white light is 12000 K in Comparative Example 16, the color temperature of the white light is 15000 K in Comparative Example 17, and the color temperature of the white light is 20000 K in Comparative Example 18.

The color temperature and the luminance were measured by a super-low luminance spectroradiometer SR-UL1 (manufactured by Topcon Corporation) arranged in a vertical direction of the display surface of the liquid crystal display device.

TABLE 6

| | | | Color | Red | Green | Blue | White |
|---|---|---|---|---|---|---|---|
| | x | y | temperature [K] | luminance | luminance | luminance | luminance |
| Example 51 | 0.3618 | 0.3707 | 4500 | 20.5% | 30.6% | 8.5% | 131.7% |
| Example 52 | 0.3455 | 0.3585 | 5000 | 19.5% | 31.1% | 9.1% | 130.7% |
| Example 53 | 0.3323 | 0.3475 | 5500 | 18.6% | 31.5% | 9.7% | 129.6% |
| Example 54 | 0.3216 | 0.3377 | 6000 | 18.0% | 31.8% | 10.2% | 128.0% |
| Example 55 | 0.3128 | 0.3292 | 6500 | 17.4% | 32.1% | 10.7% | 126.8% |
| Example 56 | 0.3054 | 0.3217 | 7000 | 17.0% | 32.2% | 11.1% | 125.2% |
| Example 57 | 0.2991 | 0.3151 | 7500 | 16.6% | 32.4% | 11.5% | 124.0% |
| Example 58 | 0.2938 | 0.3092 | 8000 | 16.3% | 32.4% | 11.8% | 122.6% |
| Example 59 | 0.2850 | 0.2993 | 9000 | 15.7% | 32.6% | 12.4% | 120.5% |
| Example 60 | 0.2783 | 0.2913 | 10000 | 15.4% | 32.7% | 12.9% | 118.3% |
| Comparative | 0.2684 | 0.2792 | 12000 | 14.8% | 32.9% | 13.6% | 115.1% |
| Example 16 | | | | | | | |
| Comparative | 0.2587 | 0.2667 | 15000 | 14.2% | 33.0% | 14.5% | 111.7% |
| Example 17 | | | | | | | |
| Comparative | 0.2491 | 0.2538 | 20000 | 13.6% | 33.1% | 15.4% | 107.8% |
| Example 18 | | | | | | | |

As shown in Table 6, the color temperature of the white light was set to 10000 K or less, so that the white luminance and the red luminance were improved. As a result, in the liquid crystal display device of the RGBY system, the red luminance can be improved, and low power consumption can be achieved. On the other hand, when the color temperature of the white light is lowered, the blue luminance is decreased, but even when the blue luminance is decreased, image quality is not greatly influenced. In addition, even when the color temperature of the white light was set to be lower, the green luminance did not greatly change.

In view of the image quality, it is more preferable that the red luminance is 12% or more, the green luminance is 30% or more, and the blue luminance is 8% or more. However, in the liquid crystal display device according to Embodiment 6, when the color temperature of the white light was 4500 K to 10000 K (Examples 51 to 60), the above condition was fulfilled. Further, also when the color temperature of the white light was 12000 K to 20000 K (Comparative Examples 16 to 18), the above condition was fulfilled, but the red luminance and the white luminance were decreased further in comparison with the case where the color temperature of the white light was 4500 K to 10000 K. Further, in view of the image quality, it is particularly preferable that the red luminance is 15% or more, the green luminance is 30% or more, and the blue luminance is 10% or more. However, in the liquid crystal display device according to Embodiment 5, when the color temperature of the white light was 6000 K to 10000 K (Examples 54 to 60), the above condition was fulfilled.

In the liquid crystal display device according to Embodiment 6, it was found that when the total area ratio of the red and blue apertures was made to be 2.0 times as large as the total area ratio of the green and yellow apertures, the red luminance could be further improved in comparison with the liquid crystal display device according to Embodiment 5.

### Embodiment 7

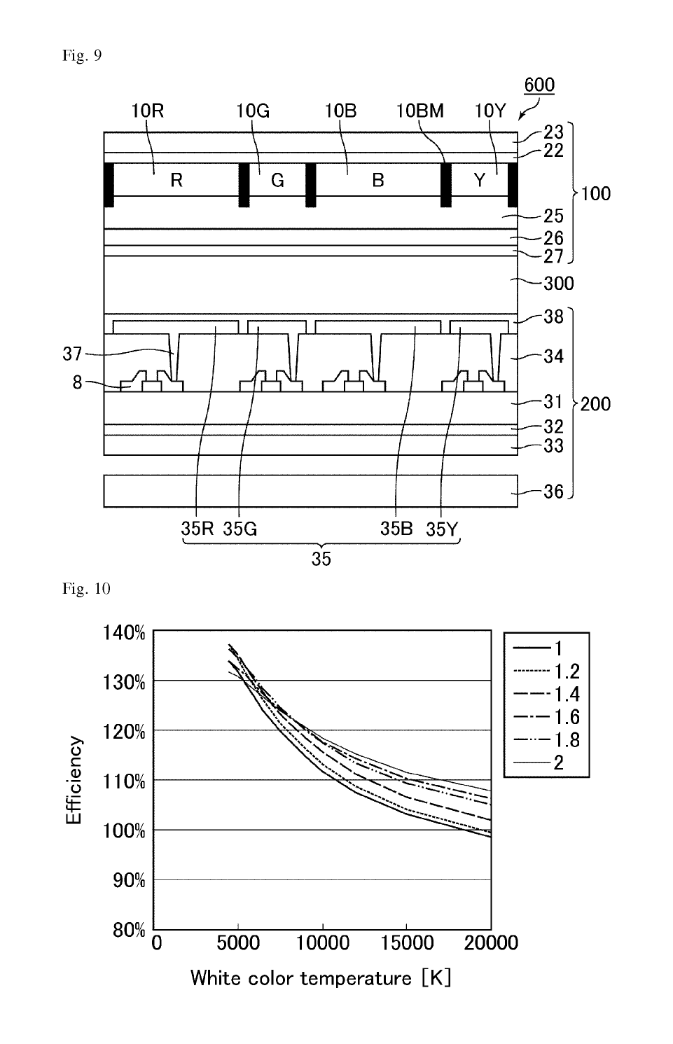

FIG. 9 is a schematic cross-sectional view illustrating a liquid crystal display device according to Embodiment 7. In the liquid crystal display device 500 according to Embodiment 1, the areas of the color filters 10R, 10G, 10B and 10Y are equal to each other. However, in a liquid crystal display device 600 according to Embodiment 7, as shown in FIG. 9, a total area of the color filters 10R and 10B is 2.2 times as large as that of the color filters 10G and 10Y, and a total area ratio of the red and blue apertures is 2.2 times as large as a total area ratio of the green and yellow apertures. Except for the above, the liquid crystal display device 600 according to Embodiment 7 is similar to the liquid crystal display device 500 according to Embodiment 1.

In the liquid crystal display device according to Embodiment 7, the color temperature of the white light was changed into 4500 K to 20000 K, and the white luminance, and the red luminance, the green luminance and the blue luminance (%) at the time when the white luminance was 100% were measured. In addition, the white luminance is luminance when the white luminance in Comparative Form 1 (the liquid crystal display device that includes the color filter substrate where the color filters of the three colors including red, blue and green are arranged, and where the color temperature of the white light to be emitted is 12000 K) is 100%. The result is shown in Table 7. The color temperature of the white light is 4500 K in Example 61, the color temperature of the white light is 5000 K in Example 62, the color temperature of the white light is 5500 K in Example 63, the color temperature of the white light is 6000 K in Example 64, the color temperature of the white light is 6500 K in Example 65, the color temperature of the white light is 7000 K in Example 66, the color temperature of the white light is 7500 K in Example 67, the color temperature of the white light is 8000 K in Example 68, the color temperature of the white light is 9000 K in Example 69, and the color temperature of the white light is 10000 K in Example 70. Further, the color temperature of the white light is 12000 K in Comparative Example 19, the color temperature of the white light is 15000 K in Comparative Example 20, and the color temperature of the white light is 20000 K in Comparative Example 21.

The color temperature and the luminance were measured by a super-low luminance spectroradiometer SR-UL1 (manufactured by Topcon Corporation) arranged in a vertical direction of the display surface of the liquid crystal display device.

TABLE 7

| | | | Color | Red | Green | Blue | White |
|---|---|---|---|---|---|---|---|
| | x | y | temperature [K] | luminance | luminance | luminance | luminance |
| Example 61 | 0.3618 | 0.3707 | 4500 | 21.4% | 30.1% | 9.1% | 134.2% |
| Example 62 | 0.3455 | 0.3585 | 5000 | 20.3% | 30.6% | 9.7% | 132.8% |
| Example 63 | 0.3323 | 0.3475 | 5500 | 19.5% | 31.0% | 10.4% | 131.0% |
| Example 64 | 0.3216 | 0.3377 | 6000 | 18.8% | 31.3% | 10.9% | 129.1% |
| Example 65 | 0.3128 | 0.3292 | 6500 | 18.3% | 31.5% | 11.4% | 127.4% |
| Example 66 | 0.3054 | 0.3217 | 7000 | 17.8% | 31.6% | 11.8% | 125.7% |
| Example 67 | 0.2991 | 0.3151 | 7500 | 17.4% | 31.7% | 12.2% | 124.1% |
| Example 68 | 0.2938 | 0.3092 | 8000 | 17.1% | 31.8% | 12.6% | 122.6% |
| Example 69 | 0.2850 | 0.2993 | 9000 | 16.6% | 32.0% | 13.2% | 120.0% |
| Example 70 | 0.2783 | 0.2913 | 10000 | 16.2% | 32.1% | 13.7% | 117.7% |
| Comparative | 0.2684 | 0.2792 | 12000 | 15.6% | 32.2% | 14.5% | 114.2% |
| Example 19 | | | | | | | |
| Comparative | 0.2587 | 0.2667 | 15000 | 15.0% | 32.3% | 15.4% | 110.4% |
| Example 20 | | | | | | | |
| Comparative | 0.2491 | 0.2538 | 20000 | 14.3% | 32.4% | 16.4% | 106.4% |
| Example 21 | | | | | | | |

In view of the image quality, it is more preferable that the red luminance is 12% or more, the green luminance is 30% or more, and the blue luminance is 8% or more. However, in the liquid crystal display device according to Embodiment 7, when the color temperature of the white light was 4500 K to 20000 K (Examples 61 to 70 and Comparative Examples 19 to 21), the above condition was fulfilled. However, in Embodiment 7, display unevenness and display roughness were observed. It is considered that since the red and blue aperture areas are 2.2 times as large as the green and yellow aperture areas and ununiformity of pixel capacity increases, display unevenness occurs. Further, when the red and blue aperture areas are increased, the entire pixels increase, and thus display roughness occurs.

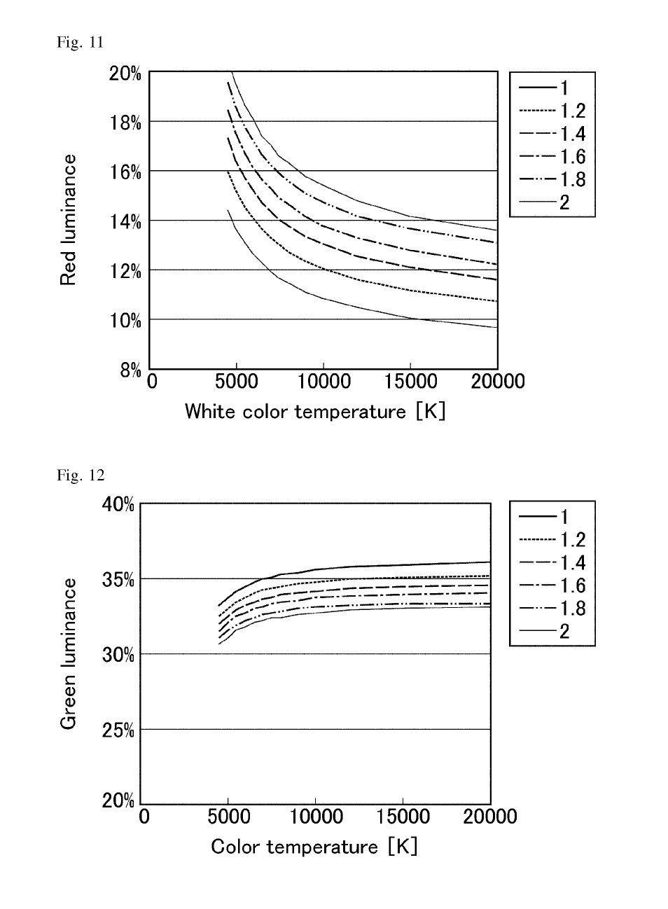

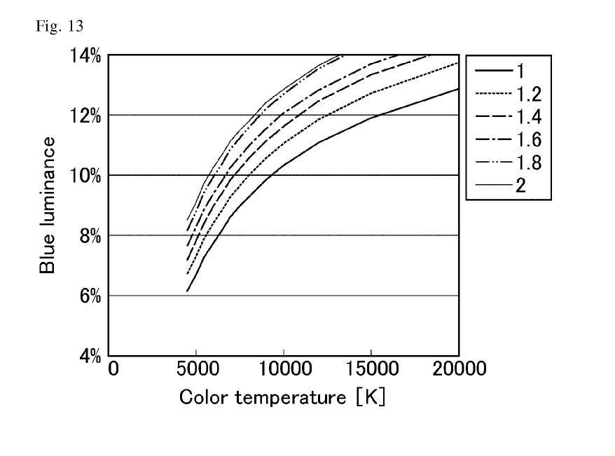

Next, a relationship between the color temperature of the white light and luminance of the respective colors in the liquid crystal display devices according to Embodiments 1 to 6 is described with reference to FIGS. 10 to 13. FIG. 10 is a graph illustrating a relationship between a color temperature of white light and white luminance in liquid crystal display devices according to Embodiments 1 to 6. FIG. 11 is a graph illustrating a relationship between a color temperature of white light and red luminance in liquid crystal display devices according to Embodiments 1 to 6. Further, FIG. 12 is a graph illustrating a relationship between a color temperature of white light and green luminance in liquid crystal display devices according to Embodiments 1 to 6. FIG. 13 is a graph illustrating a relationship between color temperature of white light and blue luminance in liquid crystal display devices according to Embodiments 1 to 6. As shown in FIG. 10, when the color temperature of the white light is 10000 K or less, the white luminance is abruptly improved. Further, as shown in FIG. 11, when the color temperature of the white light is 10000 K or less, the red luminance is abruptly improved. At the same time, as the total area ratio of the red and blue apertures is larger, the red luminance indicates more satisfactory value. In the liquid crystal display device of the RGBY system, when the color temperature of the white light is 10000 K or less and the total area ratio of the red and blue apertures is increased within a range where display unevenness and display roughness do not occur, the red luminance can be improved, and low power consumption can be achieved. On the other hand, as shown in FIG. 12, even when the color temperature of the white light is changed, the green luminance does not greatly change. As shown in FIG. 13, when the color temperature of the white light is set to be lower, the blue luminance is decreased, but even when the blue luminance is decreased, image quality is not greatly influenced.

As described in Examples 61 to 70 of Embodiment 7, in view of the improvement in the red luminance, as the total area ratio of the red and blue apertures is made to be larger, more satisfactory result is obtained. On the contrary, when the total area ratio of the red and blue apertures is made to be too large, display unevenness and display roughness might occur. In view of the above, it is preferable that the total area ratio of the red and blue apertures is 1.2 or more to 2 or less times as large as the total area ratio of the green and yellow apertures, and more preferably 1.8 or less times.

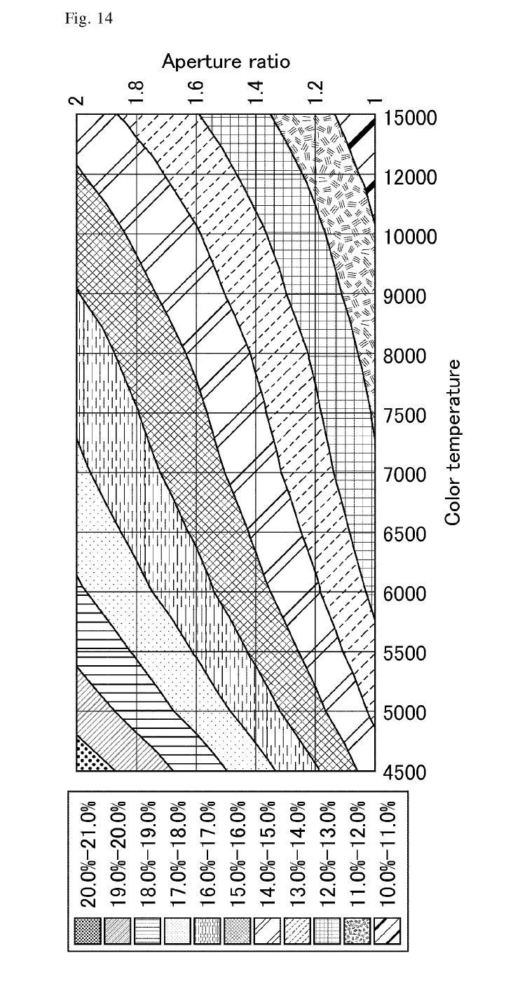

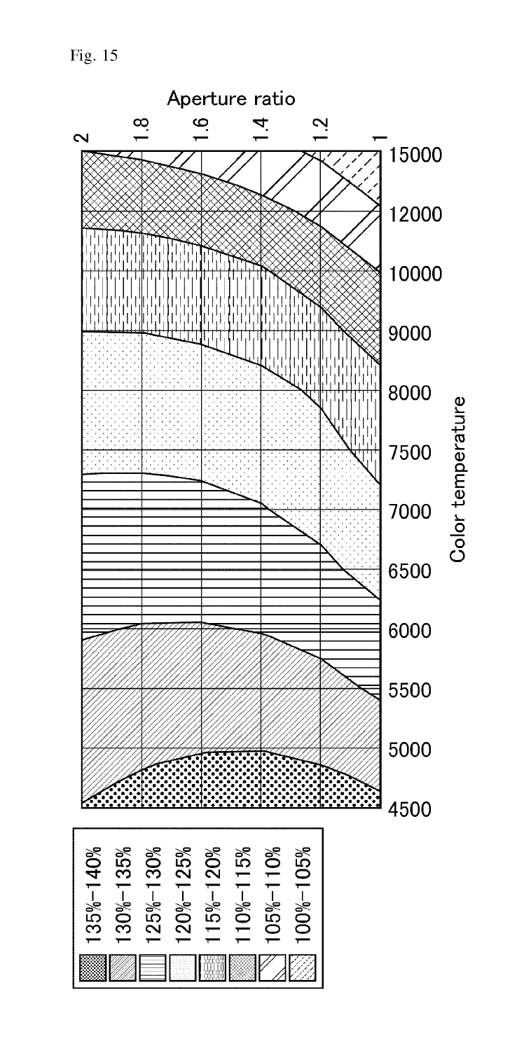

Next, a relationship between an aperture ratio and the color temperature, the red luminance and the white luminance in the liquid crystal display devices according to Embodiments 1 to 6 is described with reference to FIG. 14 and FIG. 15.

FIG. 14 is a graph illustrating red luminance (%) at a time when an aperture ratio is plotted on an ordinate and a color temperature of white light is plotted on an abscissa in liquid crystal display devices according to Embodiments 1 to 6. The aperture ratio is 1.2 in the graph means that the total area ratio (RB) of the red and blue apertures is 1.2 times as large as the total area ratio (GY) of the green and yellow apertures. As shown in FIG. 14, when the aperture ratio is increased, namely, RB is increased, the red luminance can be improved. Further, the red luminance can be improved also by lowering the color temperature of the white light.

FIG. 15 is a graph illustrating white luminance (%) at a time when an aperture ratio is plotted on an ordinate and a color temperature of white light is plotted on an abscissa in liquid crystal display devices according to Embodiments 1 to 6. As shown in FIG. 15, the white luminance can be greatly improved by lowering the color temperature of the white light. Further, also when the aperture ratio is increased, namely, RB is increased, the white luminance can be improved.

As shown in FIG. 14 and FIG. 15, in the liquid crystal display devices according to Embodiments 1 to 6, when the color temperature of the white light is lowered and the aperture ratio is increased, the white luminance and the red luminance can be improved. As a result, the red luminance can be improved and low power consumption can be achieved.

### Embodiment 8

In Embodiments 1 to 7, chromaticity of white light is represented by the color temperature (or correlated color temperature), but in Embodiment 8, the chromaticity of the white light is not represented by the color temperature. That is, the chromaticity of the white light is not set on black body radiation or near the black body radiation. Except for the above, a liquid crystal display device according to Embodiment 8 is similar to the liquid crystal display device according to Embodiment 4. In the liquid crystal display device according to Embodiment 8, the total area of the color filters 10R and 10B is 1.6 times as large as that of the color filters 10G and 10Y, and the total area ratio of the red and blue apertures is 1.6 times as large as the total area ratio of the green and yellow apertures.

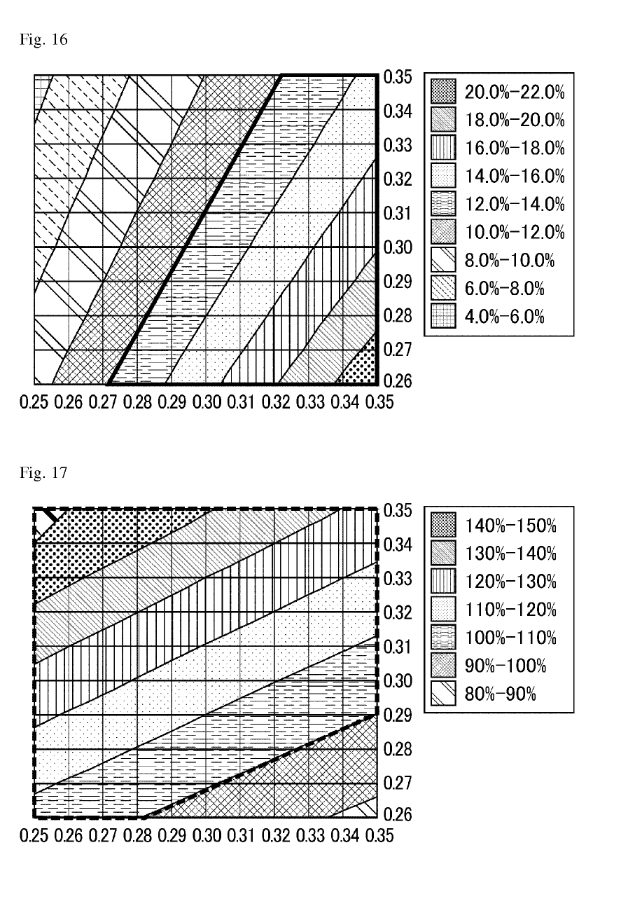

FIG. 16 is a graph illustrating red luminance (%) at a time when white luminance of white light represented by chromaticity (x, y) is 100% in Embodiment 8. The red luminance has to be 12% or more in order to maintain good display quality, and when the chromaticity (x, y) of the white light is present in a region surrounded by a thick line in FIG. 16, the red luminance is 12% or more.

FIG. 17 is a graph illustrating white luminance (%) of white light represented by chromaticity (x, y) at a time when white luminance of Comparative Form 1 (the liquid crystal display device that includes the color filter substrate where the color filters of the three colors including red, blue and green are arranged, and where the color temperature of the white light to be emitted is 12000 K) is 100% in Embodiment 8. The white luminance has to be 100% or more in order to maintain good display quality, and when the chromaticity (x, y) of the white light is present in a region surrounded by a broken line in FIG. 17, the white luminance is 100% or more.

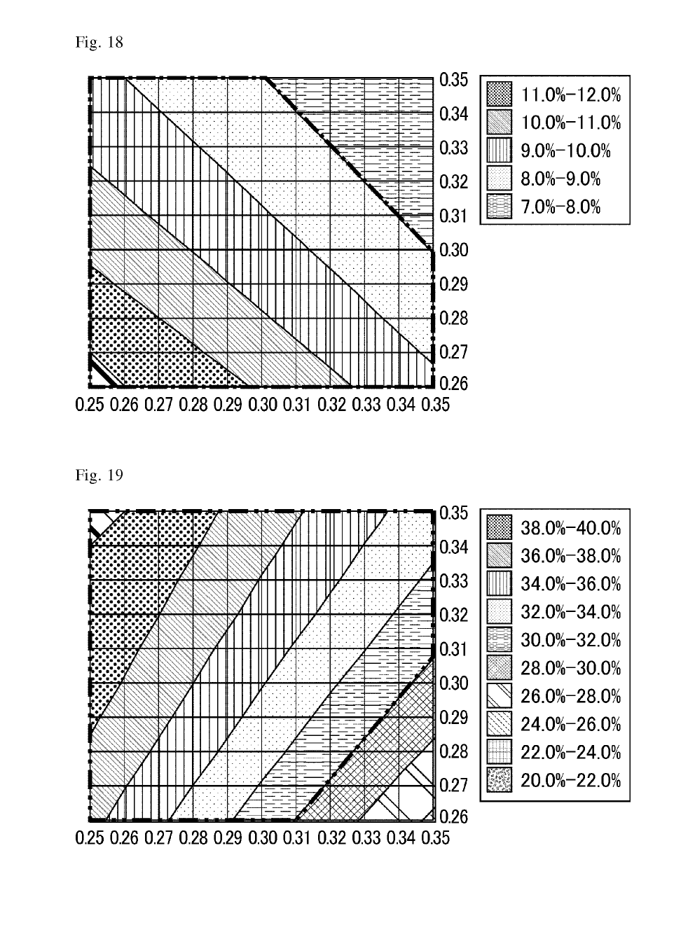

FIG. 18 is a graph illustrating blue luminance (%) at a time when white luminance of white light represented by chromaticity (x, y) is 100% in Embodiment 8. The blue luminance has to be 8% or more in order to maintain good display quality, and when the chromaticity (x, y) of the white light is present in a region surrounded by an alternate long and short dash line in FIG. 18, the blue luminance is 8% or more.

FIG. 19 is a graph illustrating green luminance (%) at a time when white luminance of white light represented by chromaticity (x, y) is 100% in Embodiment 8. The green luminance has to be 30% or more in order to maintain good display quality, and when the chromaticity (x, y) of the white light is present in a region surrounded by an alternate long and two short dashes line in FIG. 19, the green luminance is 30% or more.

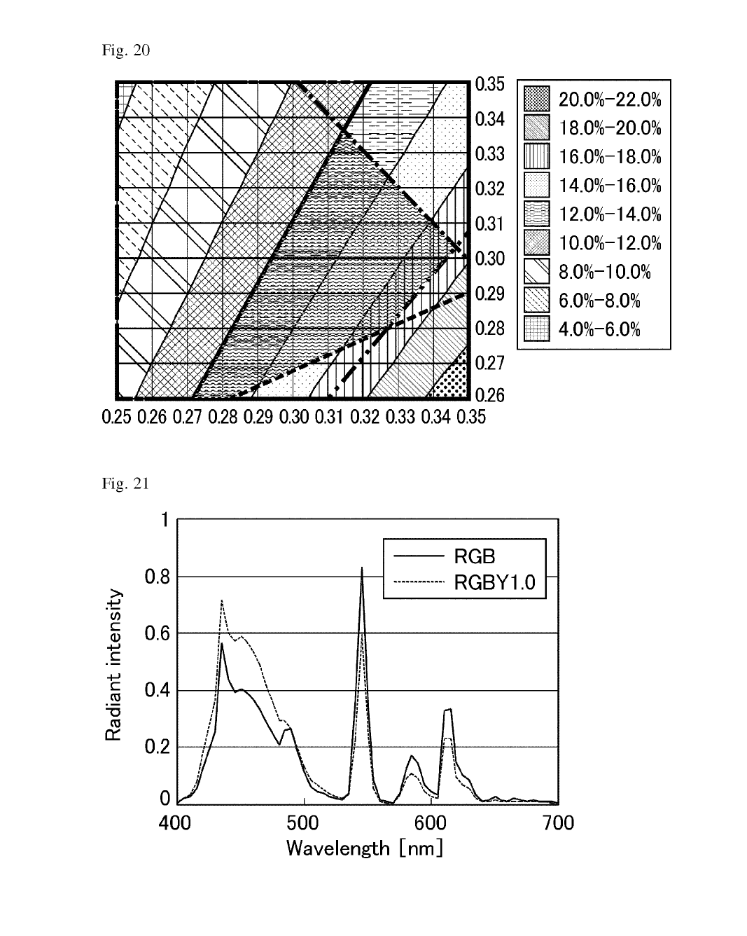

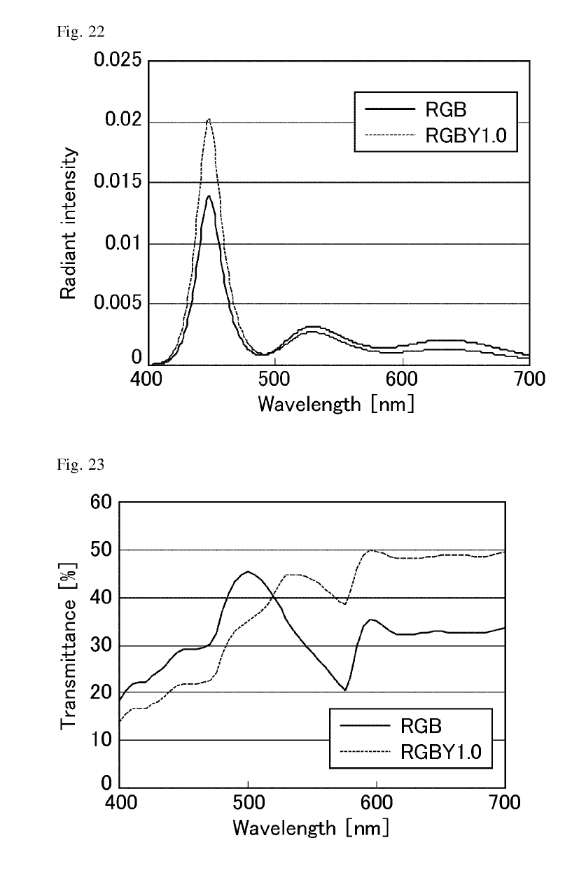

FIG. 20 is a graph where FIGS. 16 to 19 are overlapped with each other. When the chromaticity (x, y) of the white light is present in regions surrounded by a thick line, a broken line, an alternate long and short dash line, and an alternate long and two short dashes line in FIG. 20, namely, the regions indicated by a wave line pattern in FIG. 20, the red luminance is 12% or more, the white luminance is 100% or more in comparison with the white luminance of Comparative Form 1, the blue luminance is 8% or more, and the green luminance is 30% or more in the liquid crystal display device according to Embodiment 8. As a result, the red luminance can be improved and the low power consumption can be achieved.

The present application claims priority to Patent Application No. 2010-273925 filed in Japan on Dec. 8, 2010 under the Paris Convention and provisions of national law in a designated State, the entire contents of which are hereby incorporated by reference.

### REFERENCE SIGNS LIST

3: auxiliary capacitor
4: scanning line
6: signal line
7: auxiliary capacity wiring
8: TFT
9: drain lead-out wiring
10R: red filter
10G: green filter
10B: blue filter
10Y: yellow filter
10BM: black matrix
21, 31: glass substrate
22, 32: retarder
23, 33: polarizing plate
25: overcoat layer
26: counter electrode
27, 38: alignment film
34: interlayer insulating film
35: transparent electrode
36: backlight
100: counter substrate
200: TFT substrate
300: liquid crystal layer
500, 510, 520, 530, 540, 550, 600: liquid crystal display device

1. A liquid crystal display device comprising:
a color filter substrate where color filters of at least four colors are arranged for respective pixels,
wherein a color temperature of white light emitted from a display surface is less than 12000 K.

2. The liquid crystal display device according to claim 1,
wherein the color temperature of the white light emitted from the display surface is 10000 K or less.

3. The liquid crystal display device according to claim 1,
wherein the color filter substrate includes color filters of at least red, green, blue and yellow, and the liquid crystal display device includes red, green, blue and yellow apertures.

4. The liquid crystal display device according to claim 3,
wherein when a total area ratio of the red and blue apertures is represented by RB, and a total area ratio of the green and yellow apertures is represented by GY,
RB>GY.

5. The liquid crystal display device according to claim 4, wherein RB:GY=1.6:1.0.

6. The liquid crystal display device according to claim 4, wherein RB:GY=2.0:1.0.

7. The liquid crystal display device according to claim 1,
wherein when luminance of tricolor white light whose a color temperature is 12000 K and which is emitted from a display surface of a tricolor liquid crystal display device comprising a color filter substrate where color filters of three colors including red, green and blue are arranged is 100%, luminance of the white light is 100% or more.

8. The liquid crystal display device according to claim 1,
wherein when the luminance of the white light is 100%, luminance of red light emitted from the display surface of the liquid crystal display device is 12% or more.

9. The liquid crystal display device according to claim 1,
wherein when the luminance of the white light is 100%, luminance of green light emitted from the display surface of the liquid crystal display device is 30% or more.

10. The liquid crystal display device according to claim 1,
wherein when the luminance of the white light is 100%, luminance of blue light emitted from the display surface of the liquid crystal display device is 8% or more.

11. A liquid crystal display device comprising:
a color filter substrate where color filters of at least red, green, blue, and another color with higher brightness than the three colors including red, green, and blue are arranged for respective pixels,
wherein chromaticity (x, y) of white light emitted from a display surface of the liquid crystal display device is within a range that fulfills the following (1) to (4).
(1) When luminance of tricolor white light at a time when a color temperature is 12000 K is 100% in a tricolor liquid crystal display device comprising a color filter substrate where color filters of three colors including red, green, and blue are arranged, luminance of the white light is 100% or more.
(2) When the luminance of the white light is 100%, luminance of red light emitted from the display surface of the liquid crystal display device is 12% or more.
(3) When the luminance of the white light is 100%, luminance of green light emitted from the display surface of the liquid crystal display device is 30% or more.
(4) When the luminance of the white light is 100%, luminance of blue light emitted from the display surface of the liquid crystal display device is 8% or more.

12. The liquid crystal display device according to claim 11, wherein the another color is yellow.
